(19) United States
(12) Patent Application Publication
(10) Pub. No.: US 2012/0058287 A1
(43) Pub. Date: Mar. 8, 2012

(54) CATALYST COMPOUND FOR PREPARING POLYESTER RESIN, POLYESTER RESIN PREPARED USING THE COMPOUND AND CONTAINER MOLDED USING THE RESIN

(76) Inventors: Soobin Bae, Seoul (KR); Kyunghoon Kim, Daejeon (KR)

(21) Appl. No.: 13/216,930

(22) Filed: Aug. 24, 2011

(30) Foreign Application Priority Data
Sep. 2, 2010 (KR) 10-2010-0086012

(51) Int. Cl. C08F 4/16; B32B 1/02; C08F 4/26; C08G 63/85; C08L 67/02

(52) U.S. Cl. 428/35.7; 528/279; 524/604; 502/171; 502/159; 502/167; 502/170

(57) ABSTRACT

Disclosed is a catalyst compound for preparing a polyester resin. Provided are a novel catalyst compound for preparing a polyester resin, a polyester resin prepared using the compound and a container molded using the resin. The polyester resin is nontoxic, is environmentally friendly and exhibits high intrinsic viscosity and superior colors L and b, thus solving reaction speed during solid state polymerization and a yellowing phenomenon, problems associated with use of conventional titanium catalysts.

### BACKGROUND OF THE INVENTION

1. Field of the Invention

The present invention relates to a catalyst compound for preparing a polyester resin. More specifically, the present invention relates to a novel catalyst compound for preparing a polyester resin, a resin in which a yellowing phenomenon is reduced and a container molded using the resin.

2. Description of the Related Art

A polyester resin is the most generally used resin for containers, sheets, films, fibers, injection molded products and the like. Antimony oxide and antimony triacetate are the most commonly used catalysts for the preparation of polyester resins.

Advantageously, the antimony catalysts are excellent in color, are highly active for esterification (ES) and polycondensation (PC) and thus exhibit superior production efficiency. However, antimony is regulated as a substance harmful to humans due to its inherent toxicity. For this reason, there is a worldwide need for developing a novel catalyst which is safe to humans and is environmentally friendly.

In Japan, in an attempt to solve these problems, polyester resins have been prepared using germanium catalysts, the price of germanium catalysts is several tens of times higher than that of antimony catalysts, and the interest in cheap, harmless and environmentally friendly catalysts has been remarkably increased.

As an alternative to antimony catalysts, titanium compound catalysts have been developed. Polyester resins prepared from titanium catalysts disclosed in the art are disadvantageously unsuitable for forming containers due to a yellowing phenomenon, exhibit deteriorated production efficiency due to low reaction rate during solid state polymerization, involve production of a great amount of acetaldehyde due to high thermal decomposition rate in the production of articles such as containers, sheets, films and fibers, and a restriction for molding of containers due to low intrinsic viscosity (I.V).

In an attempt to solve the problems associated with titanium catalysts, U.S. Pat. No. 6,143,837 discloses a method for preparing polyester using titanium compound catalysts, and suggests use of titanium alkoxide, acetyl acetonate, dioxide, titanate and phosphite, and use of pyromellitic acid dianhydride in order to improve intrinsic viscosity (I.V) during solid state polymerization, but disadvantageously fails to improve color.

U.S. Publication Patent No. 2007/0155947 discloses a method for preparing polyester using titanium catalysts and magnesium compounds to reduce the problem of titanium catalysts, so-called “yellowing”, but this method cannot solve problems caused by the use of titanium catalysts, such as, deterioration in solid state polymerization rate, rapid thermal decomposition, and thus production of a great amount of acetaldehyde.

U.S. Pat. No. 4,217,440 suggests a variety of methods for preparing branched polyester using polyfunctional agents. This method is a technique prior to production of titanium catalysts, which is disadvantageous in that the intended object is unclear, color cannot be improved and the drawbacks of titanium catalysts, such as low solid state polymerization, cannot be solved.

### SUMMARY OF THE INVENTION

Therefore, the present invention has been made in view of the above problems, and it is an object of the present invention to provide a novel catalyst compound for preparing polyester resins, a polyester resin prepared by the compound, which is economically efficient, is environmentally friendly and is capable of solving problems such as reaction rate during solid state polymerization, generation of acetaldehyde and intrinsic viscosity suitable for molding of containers and a yellowing phenomenon, and a container molded using the resin.

In accordance with one aspect of the present invention, provided is a catalyst compound for preparing a polyester resin, comprising a titanium compound in which a compound represented by the following Formula I is dispersed in a glycol compound;

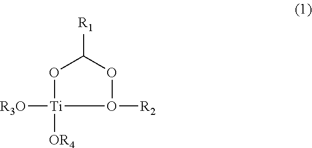

(wherein R₁ to R₄ are each independently at least one selected from the group consisting of alkyl radicals, alkenyl radicals, alkynyl radicals, cycloalkyl radicals, aryl radicals and aralkyl radicals, R₁ contains 1 to 30 carbon atoms in each radical and R₂ to R₄ each independently contain 1 to 10 carbon atoms in each radical).

The glycol compound may be at least one selected from the group consisting of ethylene glycol, diethylene glycol, triethylene glycol, tetraethylene glycol, propylene glycol, dipropylene glycol, polyethylene glycol and polypropylene glycol.

The glycol compound may be present in an amount of 10 to 200 parts by weight based on 1 part by weight of the compound represented by Formula 1.

The catalyst compound may further comprise a complexing agent and/or a metal salt.

In accordance with another aspect of the present invention, provided is a catalyst compound for preparing a polyester resin, comprising a titanium compound wherein titanium alkoxide is dispersed in a glycol compound, wherein the titanium alkoxide is at least one selected from the group consisting of tetraethyl titanate, tetrapropyl titanate, tetrabutyl titanate, tetraisopropyl titanate, tetraisobutyl titanate, butylisopropyl titanate, tetra(2-ethylhexyl)titanate, titanium acetylacetonate and triethanolamine titanate, wherein the catalyst compound further comprises a complexing agent.

The complexing agent may be at least one selected from the group consisting of hydroxycarboxylic acid, alkanolamine and aminocarboxylic acid.

The content of the complexing agent may be 100 ppm or less based on the total weight of the polyester resin.

The catalyst compound may further comprise a metal salt.

In accordance with another aspect of the present invention, provided is a catalyst compound for preparing a polyester resin, comprising a titanium compound wherein titanium alkoxide is dispersed in a glycol compound, wherein the titanium alkoxide is at least one selected from the group consisting of tetraethyl titanate, tetrapropyl titanate, tetrabutyl titanate, tetraisopropyl titanate, tetraisobutyl titanate, butylisopropyl titanate, tetra(2-ethylhexyl)titanate, titanium acetylacetonate and triethanolamine titanate, wherein the catalyst compound further comprises a metal salt.

The metal salt may comprise at least one selected from the group consisting of metals of Group 2A, aluminum, manganese, iron, cobalt, zinc, gallium and germanium.

The content of metal salt (based on elemental metal) may be 0.5 to 30 ppm with respect to the total weight of the polyester resin.

The glycol compound may be at least one selected from the group consisting of ethylene glycol, diethylene glycol, triethylene glycol, tetraethylene glycol, propylene glycol, dipropylene glycol, polyethylene glycol and polypropylene glycol.

The glycol compound may be present in an amount of 10 to 200 parts by weight with respect to 1 part by weight of the titanium alkoxide.

The content of the titanium compound (based on elemental titanium) may be 5 to 60 ppm with respect to the total weight of the polyester resin.

In accordance with another aspect of the present invention, provided is a polyester resin prepared using the catalyst compound according to the present invention.

The resin may contain a blue or red dye wherein the total content of the blue and red dyes is 0.5 to 10 ppm with respect to the total weight of the polyester resin.

In accordance with yet another aspect of the present invention, provided is a container molded using the resin according to the present invention.

### DETAILED DESCRIPTION OF THE INVENTION

Hereinafter, the present invention will be described with reference to the preferred examples in more detail.

Terms and words used in the description and the claims are not construed as being limited to conventional dictionary meanings, but are construed to have meanings and concepts corresponding to the spirit and scope of the present invention based on a principle that the inventor can properly define concepts of the terms in order to explain the invention in the best way. Therefore, since embodiments described in the description and constructions illustrated in the drawings are only exemplary embodiments of the present invention and do not speak for all of the spirit and scope of the present invention, it will be understood that various equivalents and modifications to alternate these examples may be made at the filing date.

The catalyst compound for preparing a polyester resin according to the present invention may be one of the following cases:
(1) A compound (a) below;
(2) A composite of the following compound (a) and the following compound (c);
(3) A composite of the following compound (a) and the following compound (d);
(4) A composite of the following compound (a), the following compound (c) and the following compound (d);
(5) A composite of the following compound (b) and the following compound (c);
(6) A composite of the following compound (b) and the following compound (d);
(7) A composite of the following compound (b), the following compound (c) and the following compound (d)

The compound (a) is a titanium compound in which a titanium compound (TiO₅R) represented by the following Formula I is dispersed in ethylene glycol.

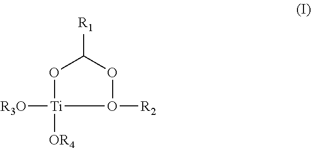

(wherein R₁ to R₄ are each independently at least one selected from the group consisting of alkyl radicals, alkenyl radicals, alkynyl radicals, cycloalkyl radicals, aryl radicals and aralkyl radicals, R₁ contains 1 to 30 carbon atoms in each radical and R₂ to R₄ each independently contain 1 to 10 carbon atoms in each radical).

The compound (b) is a titanium compound wherein titanium alkoxide is dispersed in a glycol compound, wherein the titanium alkoxide is at least one selected from the group consisting of tetraethyl titanate, tetrapropyl titanate, tetrabutyl titanate, tetraisopropyl titanate, tetraisobutyl titanate, butylisopropyl titanate, tetra(2-ethylhexyl)titanate, titanium acetylacetonate and triethanolamine titanate.

The compound (c) is a complexing agent which is at least one selected from the group consisting of hydroxycarboxylic acid, alkanolamine and aminocarboxylic acid.

The compound (d) is a metal salt which comprises at least one selected from the group consisting of metals of Group 2A, aluminum (Al), manganese (Mn), iron (Fe), cobalt (Co), zinc (Zn), gallium (Ga) and germanium (Ge).

The catalyst compound for preparing a polyester resin according to the present invention comprises a titanium compound, wherein the catalyst compound is a titanium catalyst compound comprising the compound (a) or the compound (b) to solve problems generated during preparation of polyester resins using a conventional titanium catalyst compound.

That is, the inventors of the present invention have discovered that polyester resins which can increase intrinsic viscosity during preparation of polyester resins, improve reaction rate during solid state polymerization, decrease generation of acetaldehyde by thermal degradation and reduce a yellowing phenomenon, as compared to conventional titanium catalyst compounds, can be prepared using, as a titanium compound for preparing polyester, a catalyst compound in which the compound having a novel structure represented by Formula 1 or titanium oxide is dispersed in a glycol compound, and furthermore physical properties of polyester resins can be synergistically improved by using a specific complexing agent and/or metal salt in combination with the compound of Formula 1 or the titanium oxide. The present invention has been completed, based on this discovery.

The compound of Formula 1 or titanium oxide is dispersed in a predetermined concentration in a glycol compound. In this case, the content of the glycol compound may be present in an amount of 10 to 200 parts by weight preferably, 15 to 100 parts by weight, more preferably, 20 to 30 parts by weight, with respect to 1 part by weight of the compound of Formula 1 or titanium oxide.

In addition, examples of the glycol compound include, but are not limited to, ethylene glycol, diethylene glycol, triethylene glycol, tetraethylene glycol, propylene glycol, dipropylene glycol, polyethylene glycol and polypropylene glycol. The glycol compound may be selected from ethylene glycol which exhibits superior economic efficiency, availability and easy formation of solution.

The compound having a novel structure of Formula 1 enables preparation of polyester resins which exhibit superior properties, as compared to a case where the titanium oxide is used in combination with a conventional titanium compound. In Formula 1, R₁ is specifically a C₁-C₃₀ alkyl radical, a C₃-C₃₀ cycloalkyl radical, a C₆-C₃₀ aryl radical or a C₇-C₃₀ aralkyl radical, and R₂ to R₄ are each specifically a C₁-C₁₀ alkyl radical, a C₃-C₁₀ cycloalkyl radical, a C₆-C₁₀ aryl radical or a C₇-C₁₀ aralkyl radical.

The content of the titanium catalyst compound (based on elemental titanium) is preferably 5 to 60 ppm, more preferably 20 to 40 ppm, with respect to the total weight of the polyester resin. When the content of titanium is lower than 5 ppm, production efficiency may be deteriorated due to low polymerization rate, and when the content is higher than 60 ppm, inherent activity of titanium catalyst increases, yellowing phenomenon thus increases and the amounts of formaldehyde and acetaldehyde generated may increase. Accordingly, it is preferable that the content is within this range. The titanium catalyst compound may be incorporated during one process prior to slurry preparation, esterification and polycondensation. The content and incorporation method of the titanium catalyst compound may also be applied to the titanium catalyst compound further comprising a complexing agent or metal salt described below.

The catalyst compound for preparing polyester resins may further comprise a complexing agent or metal salt in order to improve intrinsic viscosity of the polyester resin and reduce the yellowing phenomenon.

A small amount of complex may be produced during the reaction process, when the complexing agent is incorporated in an excess amount. Accordingly, in order to prevent the production of the complex, the content of the complexing agent is preferably 100 ppm or less with respect to the total weight of the polyester resin. The content of the complexing agent is most preferably 10 to 30 ppm from the viewpoint of improving intrinsic viscosity and reducing yellowing.

In addition, examples of the complexing agent include, but are not limited to, hydroxycarboxylic acid, alkanolamine and aminocarboxylic acid. Preferred is aminocarboxylic acid which imparts good color tone to prepared polyester resins and improves intrinsic viscosity.

The content of metal salt (based on elemental metal) is preferably 0.5 to 30 ppm, more preferably 5 to 15 ppm, most preferably about 10 ppm, with respect to the total weight of the polyester resin. The titanium catalyst compound further comprising a metal salt can improve intrinsic viscosity and colors L and b of prepared polyester resins, as compared to a titanium catalyst compound further comprising no metal salt. However, when the content of metal salt is lower than 0.5 ppm, improvement effects of additionally incorporated metal salt may not be significant and when the content is higher than 30 ppm, the activity of titanium catalyst is excessively improved and color L and color b may thus become dark. That is, when the content of metal salt is within this preferred range, stable activity of the titanium catalyst compound can be obtained and polyester resins having superior color tone can thus be prepared.

In addition, examples of the metal constituting the metal salt include metals of Group 2A, aluminum, manganese, iron, cobalt, zinc, gallium and germanium. Examples of the metals of Group 2A include beryllium (Be), magnesium (Mg), calcium (Ca), strontium (Sr) and barium (Ba). Of these, one selected from the group consisting of barium, aluminum, manganese, iron, cobalt, zinc, gallium and germanium is preferred, in terms of improving intrinsic viscosity and color tone. Most preferred is germanium.

In addition, the metal salt comprising the metal may be provided in various forms such as chloride, carbonate, acetate and nitrate. Of the most preferred metal salts, germanium salts, germanium tetrachloride (GeCl₄) which is economically efficient and is easily available is preferred.

Meanwhile, the method for preparing polyester resins using the catalyst compound for preparing polyester resins of the present invention may be one used in accordance with a common method and is not particularly limited. For example, polyester resins may be prepared in accordance with the following method using a batch-type reactor. The polyester resins may be prepared in a continuous method and is not particularly limited.

First, a dicarboxylic acid compound and a diol compound as polyester materials are incorporated together with the titanium catalyst compound of the present invention to form slurry, esterification is performed in an esterification reactor to produce an oligomer, when an esterification ratio (a ratio of carboxylic groups in the dicarboxylic acid compound which react with the diol component and are esterified, with respect to the total carboxylic groups present therein) reaches at least 90%, preferably at least 93%, and the produced oligomer is polycondensed to a polymerization degree of 100 or more in a polycondensation (PC) reactor and cut in water to polymerize polyester resins. At this time, the titanium catalyst compound may be incorporated in an initial stage of polycondensation after esterification is performed without any catalyst compound, as mentioned above.

Then, the polycondensed product is extruded to produce liquid chips and the liquid chips are crystallized to perform solid state polymerization and thereby produce solid chips.

The dicarboxylic acid compound used in the preparation of polyester resins using the titanium catalyst compound according to the present invention is a diacidic compound which contains an aromatic molecule as a main ingredient. Examples of dicarboxylic acid compound used in the present invention include phthalic acid, terephthalic acid, isophthalic acid, dibromoisophthalic acid, sodium sulfoisophthalate, phenylene dioxydicarboxylic acid, 4,4′-diphenyldicarboxylic acid, 4,4′-diphenyl ether dicarboxylic acid, 4,4′-diphenylketone dicarboxylic acid, 4,4′-diphenoxy ethane dicarboxylic acid, 4,4′-diphenyl sulfone dicarboxylic acid, and 2,6-naphthalene dicarboxylic acid. Preferred is terephthalic acid, isophthalic acid or a mixture thereof. When terephthalic acid and other dicarboxylic acid compounds are mixed, the ratio of terephthalic acid (or derivatives thereof) is preferably 90 mole % or more, more preferably 95 mole % or more, most preferably 99 mole % or more.

In addition, the diol compound may be ethylene glycol, diethylene glycol, 1,4-butanediol, 1,3-propanediol, 1,4-cyclohexane dimethanol, neopentyl glycol, or the like. Preferred is ethylene glycol or neopentyl glycol. When ethylene glycol and other diol compound are mixed, the ratio of ethylene glycol is preferably 95 mole % or more, more preferably, 98 mole % or more.

A content ratio (molar ratio) of the dicarboxylic acid compound to the diol compound may be 1:1 to 1:2, preferably, 1:1.1 to 1:1.3, in order to prevent deterioration in physical properties of prepolymers.

In addition, the esterification reaction is for example carried out using a single esterification reactor or a multi-step reaction apparatus including a plurality of esterification reactors connected in series, while removing water produced during the reaction of the diol compound under reflux and remaining diol compound to the outside of the system, until the esterification ratio reaches a predetermined level. In addition, when the single esterification reactor is used, the reaction may be carried out under stirring at a temperature of 210 to 270° C., preferably 250 to 260° C., and at a pressure of 0.1 to 5 kg/cm², preferably, 0.5 to 3 kg/cm² for 1 to 10 hours, and when a plurality of esterification reactors is used, the reaction may be carried out under stirring at a temperature of 230 to 280° C., preferably 250 to 270° C., and at a pressure of 0.1 to 3 kg/cm², preferably 0.5 to 1.5 kg/cm² for 1 to 10 hours.

The polycondensation reaction for example may be carried out using a single esterification reactor or a multi-step reaction apparatus including a plurality of esterification reactors connected in series, while removing the diol compound produced under reduced pressure to the outside of the system. In addition, when the single esterification reactor is used, the reaction may be carried out under stirring at a temperature of 250 to 300° C., preferably 270 to 290° C., and at a pressure of 0.1 to 5 torr, preferably, 0.5 to 2 torr for 1 to 20 hours, and when a plurality of esterification reactors is used, the reaction may be carried out under stirring at a temperature of 250 to 290° C., preferably 270 to 280° C., and at a pressure of 0.1 to 10 torr, preferably 0.5 to 5 torr for 1 to 20 hours.

For the polyester resin according to the present invention, a blue or red dye may be incorporated as a color-improving agent in the process of forming the slurry in order to improve color of the container molded from the polyester resin. Preferably, the blue dye is an anthracene blue dye and the red dye is also an anthracene red dye. At this time, the content of the color-improving agent is preferably 0.5 to 10 ppm, more preferably 2 to 6 ppm, with respect to the total weight of the polyester resin. When the content of the color-improving agent is less than 0.5 ppm, color improvement effects may be insufficient, and when the content of color-improving agent is higher than 10 ppm, color may disadvantageously become dark.

Meanwhile, a toner to improve color in the process of preparing polyester resins and a thermal stabilizer to prevent variation in physical and chemical properties of resins caused by heat may be further incorporated. At this time, the toner is preferably incorporated during preparation of the slurry and the thermal stabilizer may be incorporated during preparation of the slurry. However, according to the present invention, the yellowing phenomenon can be further improved, when the thermal stabilizer is incorporated in an esterification reactor, unlike conventional titanium catalyst compounds. Accordingly, the thermal stabilizer is preferably incorporated during the esterification reaction and more preferably at the end of the esterification reaction.

The toner may be a cobalt compound and is preferably cobalt acetate. In addition, the cobalt compound may be present in an amount of 10 to 200 ppm, more preferably 50 to 150 ppm, even more preferably, 90 to 110 ppm with respect to the total weight of the polyester resin prepared in accordance with the present invention. When the content of the cobalt compound is lower than 10 ppm, Color b may be improved and when the content exceeds 200 ppm, the cost is disadvantageous and Color L and Color b may become dark.

The thermal stabilizer may be a phosphorous compound and examples thereof include pentavalent phosphorous compounds such as trimethyl phosphate, triethyl phosphate, tributyl phosphate, trioctyl phosphate, triphenyl phosphate, tricresyl phosphate, methyl acid phosphate, ethyl acid phosphate, isopropyl acid phosphate, butyl acid phosphate, diethyl phosphate, monobutyl phosphate, dibutyl phosphate, dioctyl phosphate, and triethylene glycol acid phosphate. Preferred are phosphate, triethyl phosphate and ethyl acid phosphate. More preferred is triethyl phosphate. In addition, the content of the phosphorous compound may be present in an amount of 5 to 150 ppm, preferably 60 to 100 ppm, with respect to the total weight of the polyester resin prepared in accordance with the present invention. When the content of the phosphorous compound is lower than 5 ppm, the reaction speed may decrease and a yellowing phenomenon may occur, and when the content exceeds 150 ppm, the cost is disadvantageous and fuming may occur during the polycondensation and have an adverse effect on the reaction.

### Preparation Examples

A 5 liter batch-type polymerization apparatus was used to prepare polyester resins according to the present invention. That is, a single esterification reactor, a single polycondensation reactor and a polymerization apparatus provided with a cutting system were used as reactors and the esterification reaction was performed for 4 to 5 hours, the polycondensation reaction was performed for 2.5 to 3.5 hours, and a polymerization apparatus for preparing polyester resins having a sample supply amount of 2 to 3 kg was used. 100 moles by parts of terephthalic acid, 120 moles by parts of ethylene glycol, 100 ppm of cobalt acetate as a toner and a catalyst compound were mixed in the reactors to form slurry. Then, an esterification reaction was performed at a temperature of 250 to 260° C. at a pressure of 1 to 2 kg/cm² and 80 ppm of triethyl phosphate as a thermal stabilizer was incorporated at the end of the esterification reaction. At this time, a color enhancer (dye) was further incorporated. Then, an oligomer prepared in an esterification reaction was transferred to a polycondensation reactor and polycondensation was carried out at a temperature of 270 to 290° C. and a pressure of 0.5 to 2 torr. Then, the polycondensed product was extruded to prepare liquid chips and the liquid chips were crystallized to perform solid state polymerization and thereby produce solid chips. The solid state polymerization was carried out in a 5 liter batch-type polymerization apparatus at a temperature of 220 to 230° C. and at a pressure of 0.4 torr or less for 10 hours.

### Examples 1 to 6

### Application of Titanium Compound and Metal Salt

The compositions of Examples and Comparative Examples based on the titanium compound and contents thereof and metal salts and contents thereof according to a preferred embodiment are shown in Table 1. The measurement results of physical properties of polyester resins prepared according to the composition of Examples are shown in Table 2. A titanium compound in which 1 part by weight of TiO₅R (TiO₅C₄H₁₂) is uniformly dispersed in 20 parts by weight of glycol ethylene was used as the titanium compound and a germanium salt (germanium tetrachloride) was used as the metal salt. The contents of respective compounds were based on the total weight of the polyester resin, which were identical in the all of the following examples and comparative examples.

TABLE 1

| | | | | Heat stabilizer | Toner |
|---|---|---|---|---|---|
| | Catalyst compounds | | | (triethyl | (cobalt |
| Examples | TiO₅R | TiO₂ | Ge salt | phosphate) | acetate) |
| Unit | ppm | ppm | ppm | ppm | ppm |
| Ex. 1 | 20 | — | — | 80 | 100 |
| Ex. 2 | 30 | — | — | 80 | 100 |
| Ex. 3 | 50 | — | — | 80 | 100 |
| Ex. 4 | 30 | — | 5 | 80 | 100 |
| Ex. 5 | 30 | — | 10 | 80 | 100 |
| Ex. 6 | 30 | — | 15 | 80 | 100 |
| Comp. Ex. 1 | — | 30 | — | 80 | 100 |
| Comp. Ex. 2 | — | 30 | 5 | 80 | 100 |
| Comp. Ex. 3 | — | 30 | 10 | 80 | 100 |
| Comp. Ex. 4 | — | 30 | 15 | 80 | 100 |

TABLE 2

| | I.V. | Color | | I.V. | Color | |
|---|---|---|---|---|---|---|
| | (Liquid | (Liquid chip) | | (Solid | (Liquid chip) | |
| Examples | chip) | L | b | chip) | L | b |
| Ex. 1 | 0.59 | 55.21 | −0.98 | 0.73 | 80.14 | −1.34 |
| Ex. 2 | 0.61 | 55.23 | −0.76 | 0.75 | 80.19 | −1.22 |
| Ex. 3 | 0.63 | 55.14 | −0.54 | 0.78 | 80.39 | −0.78 |
| Ex. 4 | 0.61 | 57.02 | −1.25 | 0.75 | 80.42 | −1.50 |
| Ex. 5 | 0.61 | 58.78 | −1.54 | 0.76 | 82.24 | −1.78 |
| Ex. 6 | 0.63 | 59.21 | −1.23 | 0.78 | 79.33 | −1.45 |
| Comp. Ex. 1 | 0.57 | 52.41 | 0.24 | 0.70 | 78.24 | 0.22 |
| Comp. Ex. 2 | 0.59 | 53.44 | 0.22 | 0.72 | 75.33 | 0.14 |
| Comp. Ex. 3 | 0.60 | 54.12 | 0.12 | 0.72 | 76.22 | 0.10 |
| Comp. Ex. 4 | 0.62 | 54.14 | 0.17 | 0.73 | 76.84 | 0.15 |

The measurement results of physical properties were evaluated with reference to Tables 1 and 2 as follows. First, when comparing the case where TiO₅R of the present invention was used as a titanium compound (Comparative Examples 1 to 4) with the case where TiO₄R was used (Examples 1 to 6), it can be seen that intrinsic viscosity (I.V) of liquid chips overall slightly increased, but rapidly increased under the identical content conditions (Example 2 and Comparative Example 1, and Example 4 and Comparative Example 2). In addition, intrinsic viscosity (I.V) of solid chips overall increased and both Color L and Color b were improved.

At this time, it can be seen that, as the content of TiO₅R increases (Examples 1 to 3), I.V increases. Accordingly, it can be seen that reaction rate during solid state polymerization can be increased, as compared to a case using a conventional titanium compound. It can be seen that Color L does not greatly vary and Color b is slightly deteriorated. Accordingly, the content of TiO₅R should be within a preferred range and deterioration of Color b within the preferred range can be accomplished by a complexing agent or metal salt which may be further contained according to the present invention.

Meanwhile, it can be seen that the case where a germanium salt is added to TiO₅R (Examples 4 to 6) exhibited improved I.V, Color L and Color b, as compared to the case where the equivalent amount of TiO₅R was used (Example 2). At this time, it can be also seen that this improvement is effective when the content of germanium salt is 5 to 15 ppm, and is most effective when the content is about 10 ppm.

### Examples 7 to 11

### Application of Titanium Compound and Complexing Agent

As other preferred embodiment of the present invention, the compositions of Examples according to the content of catalyst compounds of comprising TiO₅R and a complexing agent are shown in Table 3. The measurement results of physical properties of polyester resin prepared according to the compositions of Examples are shown in Table 4. A titanium compound in which 1 part by weight of TiO₅R (TiO₅C₄H₁₂) is uniformly dispersed in 20 parts by weight of glycol ethylene was used as the titanium compound. A titanium compound in which 1 part by weight of TiO₅R (TiO₅C₄H₁₂) is uniformly dispersed in 20 parts by weight of glycol ethylene was used as the titanium compound. Hydroxycarboxylic acid, alkanolamine or aminocarboxylic acid was used as the complexing agent.

TABLE 3

| | | | | Heat stabilizer | Toner |
|---|---|---|---|---|---|
| | Catalyst compounds | | | (triethyl | (cobalt |
| Examples | Complexing agent | | TiO₅R | phosphate) | acetate) |
| Unit | ppm | ppm | ppm | ppm | ppm |
| Ex. 7 | Hydroxycarboxylic | 10 | 30 | 80 | 100 |
| | acid | | | | |
| Ex. 8 | Alkanolamine | 10 | 30 | 80 | 100 |
| Ex. 9 | Aminocarboxylic | 10 | 30 | 80 | 100 |
| | acid | | | | |
| Ex. 10 | Aminocarboxylic | 20 | 30 | 80 | 100 |
| | acid | | | | |
| Ex. 11 | Aminocarboxylic | 30 | 30 | 80 | 100 |
| | acid | | | | |

TABLE 4

| | I.V. | Color | | I.V. | Color | |
|---|---|---|---|---|---|---|
| | (Liquid | (Liquid chip) | | (Solid | (Liquid chip) | |
| Examples | chip) | L | b | chip) | L | b |
| Ex. 7 | 0.62 | 59.20 | −0.81 | 0.78 | 82.19 | −1.25 |
| Ex. 8 | 0.61 | 59.24 | −0.77 | 0.79 | 81.39 | −1.24 |
| Ex. 9 | 0.63 | 58.88 | −0.82 | 0.80 | 80.27 | −1.47 |
| Ex. 10 | 0.63 | 59.43 | −0.85 | 0.79 | 82.91 | −1.67 |
| Ex. 11 | 0.62 | 59.60 | −0.84 | 0.81 | 81.42 | −1.51 |

From Tables 3 and 4 above, it can be seen that the cases where TiO₅R as the catalyst compound and a complexing agent are applied (Examples 7 to 9) exhibit improved I.V, Color L and Color b, as compared to the cases where only the equivalent amount of TiO₅R is applied (see Example 2). According to the present invention, it is most preferable that aminocarboxylic acid which exhibits the most excellent good color L and b and the highest intrinsic viscosity is used. In addition, the content of aminocarboxylic acid was controlled as a preferred complexing agent. As a result, it can be seen that the improvement is effective, when the content of complexing agent is 10 to 30 ppm, and the improvement is most effective when the content was about 20 ppm.

### Examples 12 to 14

### Application of Titanium Compound, Complexing Agent and Metal Salt

As other preferred examples of the present invention, the compositions of Examples according to the content of catalyst compounds comprising TiO₅R, a complexing agent and a metal salt are shown in Table 5. The measurement results of physical properties of polyester resin prepared according to the composition of Examples are shown in Table 6. Aminocarboxlic acid was used as the complexing agent and a germanium salt was used as the metal salt.

TABLE 5

| | Catalyst compounds | | | Heat stabilizer | Toner |
|---|---|---|---|---|---|
| | Aminocarboxylic | | | (triethyl | (cobalt |
| Examples | acid | TiO₅R | Ge salt | phosphate) | acetate) |
| Unit | ppm | ppm | ppm | ppm | ppm |
| Ex. 12 | 10 | 30 | 5 | 80 | 100 |
| Ex. 13 | 20 | 30 | 10 | 80 | 100 |
| Ex. 14 | 30 | 30 | 15 | 80 | 100 |

TABLE 6

| | I.V. | Color | | I.V. | Color | |
|---|---|---|---|---|---|---|
| | (Liquid | (Liquid chip) | | (Solid | (Liquid chip) | |
| Examples | chip) | L | b | chip) | L | b |
| Ex. 12 | 0.62 | 59.20 | −1.61 | 0.78 | 82.19 | −1.85 |
| Ex. 13 | 0.61 | 59.24 | −1.75 | 0.79 | 81.39 | −1.97 |
| Ex. 14 | 0.63 | 58.88 | −1.70 | 0.80 | 83.27 | −1.84 |

From Tables 5 and 6 above, it can be seen that the cases where TiO₅R as a catalyst compound, a complexing agent and a metal salt are applied (Examples 12 to 14) exhibit overall improved Color L and Color b, as compared to the cases where the equivalent amounts of TiO₅R and complexing agent alone are applied (Examples 9 to 11), and the case where the equivalent amounts of TiO₅R and metal salt alone are applied (Example 4) and, at this time, the improvement is the most effective, when the content of complexing agent is about 20 ppm and the content of metal salt is about 10 ppm.

### Examples 15 to 21

### Application of Catalyst Compound and Dye

As other preferred embodiments of the present invention, the compositions of Examples according to the contents of blue and red dyes applied to catalyst compounds comprising TiO₅R, a complexing agent and a metal salt are shown in Table 7. The measurement results of physical properties of polyester resin prepared according to the compositions of Examples are shown in Table 8. An anthracene dye was used as the blue and red dyes. The catalyst compound used herein was composed of 30 ppm of TiO₅R, 20 ppm of aminocarboxylic acid and 5 ppm of germanium salt (see Example 13).

TABLE 7

| | Heat | | | |
|---|---|---|---|---|
| | stabilizer | Toner | Blue | Red |
| Unit | ppm | Ppm | ppm | ppm |
| Ex. 15 | 80 | 100 | 1 | 2 |
| Ex. 16 | 80 | 100 | 3 | 2 |
| Ex. 17 | 80 | 100 | 4 | 2 |
| Ex. 18 | 80 | 100 | 5 | 2 |
| Ex. 19 | 80 | 100 | 6 | 2 |
| Ex. 20 | 80 | 100 | 7 | 2 |
| Ex. 21 | 80 | 100 | 8 | 2 |

TABLE 8

| | I.V. | Color | | I.V. | Color | |
|---|---|---|---|---|---|---|
| | (Liquid | (Liquid chip) | | (Solid | (Liquid chip) | |
| | chip) | L | b | chip) | L | b |
| Ex. 15 | 0.62 | 57.20 | −2.23 | 0.75 | 81.02 | −2.46 |
| Ex. 16 | 0.61 | 56.24 | −2.79 | 0.78 | 80.01 | −2.89 |
| Ex. 17 | 0.63 | 55.88 | −3.21 | 0.73 | 78.21 | −3.50 |
| Ex. 18 | 0.60 | 55.20 | −4.15 | 0.76 | 75.20 | −4.76 |
| Ex. 19 | 0.62 | 54.07 | −4.75 | 0.77 | 74.20 | −5.55 |
| Ex. 20 | 0.60 | 54.03 | −6.90 | 0.75 | 72.11 | −6.80 |
| Ex. 21 | 0.58 | 54.02 | −7.54 | 0.74 | 70.11 | −9.20 |

From Tables 7 and 8 above, it can be seen that, as the content of blue dye in the catalyst compound increases, both Color b and Color L decrease. Accordingly, according to the present invention, superior polyester resins can be prepared within the content range of Examples 15 to 21, but it is most preferable that the content of the dye is 3 to 6 ppm (Examples 15 to 17), from the viewpoint of exhibiting good color b and more superior color L. When a container is molded from the polyester resin prepared using the dye, it has excellent transparency and is bluish.

As apparent from the afore-going, the present invention provides a polyester resin prepared from the catalyst compound according to the present invention, which exhibits superior intrinsic viscosity and good color L and b, is nontoxic, is environmentally friendly, deteriorates generation of acetaldehyde by thermal decomposition and improves physical properties (for example, reduces a yellowing phenomenon), when used as a resin for molding containers, as compared to the case in which conventional titanium catalysts are used. The catalyst compound according to the present invention further comprises an optimum content of complexing agent and metal salt and thus provides polyester resins with remarkably improved physical properties and containers molded using the same, as compared to the case of using conventional titanium catalysts.

The present invention provides a catalyst compound for preparing polyester resins, in which a titanium compound having a novel structure or titanium oxide is dispersed in a glycol compound, a polyester resin prepared using the compound, which is environmentally friendly, exhibits superior intrinsic viscosity, and deteriorates generation of acetaldehyde by thermal decomposition, as compared to the case in which conventional titanium catalysts are used, and is thus suitable for use as a resin for molding containers, and a container molded using the resin.

In addition, the present invention provides a polyester resin and a container molded using the resin, which maintain further improved color L and b values and thus reduce the yellowing phenomenon, by using a titanium catalyst compound containing in optical contents of optimal components such as a complexing agent and a metal salt.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A catalyst compound for preparing a polyester resin, comprising a titanium compound in which a compound represented by the following Formula I is dispersed in a glycol compound; 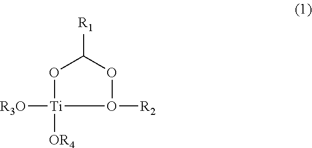
(wherein R₁ to R₄ are each independently at least one selected from the group consisting of alkyl radicals, alkenyl radicals, alkynyl radicals, cycloalkyl radicals, aryl radicals and aralkyl radicals, R₁ contains 1 to 30 carbon atoms in each radical and R₂ to R₄ each independently contain 1 to 10 carbon atoms in each radical).

2. The catalyst compound according to claim 1, wherein the glycol compound is at least one selected from the group consisting of ethylene glycol, diethylene glycol, triethylene glycol, tetraethylene glycol, propylene glycol, dipropylene glycol, polyethylene glycol and polypropylene glycol.

3. The catalyst compound according to claim 1, wherein the glycol compound is present in an amount of 10 to 200 parts by weight based on 1 part by weight of the compound represented by Formula 1.

4. The catalyst compound according to claim 1, wherein the catalyst compound further comprises a complexing agent and/or a metal salt.

5. A catalyst compound for preparing a polyester resin, comprising a titanium compound wherein titanium alkoxide is dispersed in a glycol compound, wherein the titanium alkoxide is at least one selected from the group consisting of tetraethyl titanate, tetrapropyl titanate, tetrabutyl titanate, tetraisopropyl titanate, tetraisobutyl titanate, butylisopropyl titanate, tetra(2-ethylhexyl)titanate, titanium acetylacetonate and triethanolamine titanate, wherein the catalyst compound further comprises a complexing agent.

6. The catalyst compound according to claim 4, wherein the complexing agent is at least one selected from the group consisting of hydroxycarboxylic acid, alkanolamine and aminocarboxylic acid.

7. The catalyst compound according to claim 4, wherein the content of the complexing agent is 100 ppm or less based on the total weight of the polyester resin.

8. The catalyst compound according to claim 5, wherein the catalyst compound further comprises a metal salt.

9. A catalyst compound for preparing a polyester resin, comprising a titanium compound wherein titanium alkoxide is dispersed in a glycol compound, wherein the titanium alkoxide is at least one selected from the group consisting of tetraethyl titanate, tetrapropyl titanate, tetrabutyl titanate, tetraisopropyl titanate, tetraisobutyl titanate, butylisopropyl titanate, tetra(2-ethylhexyl)titanate, titanium acetylacetonate and triethanolamine titanate, wherein the catalyst compound further comprises a metal salt.

10. The catalyst compound according to claim 4, wherein the metal salt comprises at least one selected from the group consisting of metals of Group 2A, aluminum, manganese, iron, cobalt, zinc, gallium and germanium.

11. The catalyst compound according to claim 4, wherein the content of metal salt (based on elemental metal) is 0.5 to 30 ppm with respect to the total weight of the polyester resin.

12. The catalyst compound according to claim 5, wherein the glycol compound is at least one selected from the group consisting of ethylene glycol, diethylene glycol, triethylene glycol, tetraethylene glycol, propylene glycol, dipropylene glycol, polyethylene glycol and polypropylene glycol.

13. The catalyst compound according to claim 5, wherein the glycol compound is present in an amount of 10 to 200 parts by weight with respect to 1 part by weight of the titanium alkoxide.

14. The catalyst compound according to claim 1, wherein the content of the titanium compound (based on elemental titanium) is 5 to 60 ppm with respect to the total weight of the polyester resin.

15. A polyester resin prepared using the catalyst compound according to claim 1.

16. The catalyst compound according to claim 15, wherein the resin contains a blue or red dye and the total content of the blue and red dyes is 0.5 to 10 ppm with respect to the total weight of the polyester resin.

17. A container molded using the resin according to claim 15.
